(19) United States
(12) Patent Application Publication
(10) Pub. No.: US 2023/0256325 A1
(43) Pub. Date: Aug. 17, 2023

(54) Method for card and lot selection based on measurements of movement, biometrics, or environmental data

(71) Applicant: James Keith Wood, Dallas, TX (US)

(72) Inventor: James Keith Wood, Dallas, TX (US)

(21) Appl. No.: 17/943,805

(22) Filed: Sep. 13, 2022

Related U.S. Application Data
(60) Provisional application No. 63/268,163, filed on Feb. 17, 2022.

(51) Int. Cl. A63F 13/211; A63F 13/215; A63F 1/12

(52) U.S. Cl. CPC A63F 13/211; A63F 13/215; A63F 1/12; A63F 2300/1075; A63F 2300/1081

(57) ABSTRACT

The present invention provides a method for selecting a card, lot, or number using a shuffling process that relies on measurements of movement, biometrics, or environmental data within interactive electronic media. The invention provides an alternative to random number generators for media which relies on random selection outputs such as divination tools or a game of chance. The incorporation of a user's movement or environmental data into the selection process provides an element of interest and amusement. The present invention also provides for a selection method that reliably generates a unique selection upon each use by utilizing precise measurements and mathematical formulas to catalogue and shuffle the cards or lots in a system.

### CROSS-REFERENCE TO RELATED APPLICATIONS

This nonprovisional patent application claims the earlier filing date of provisional utility patent application 63/268,163 filed on Feb. 17, 2022 under the same name.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to a method for card, lot, or number selection based on movement, biometrics, or environmental data detection sensors for use in interactive electronic media. Games of chance have been an established pastime for centuries. There are myriad examples of card and lot-based games or systems for entertainment, religious, or even simple selection purposes. Modern technology has made it possible to operate these systems on computer software across many types of devices. Interactive electronic media here can be narrowed down to computer-operated systems in which the user must participate in some fashion, by choice, selection, or other input methods. Some systems require user input that is random in that there is no right or wrong input and the user's selection does not result from a conscious choice made by the user. For example, this is true of any system which uses a die to arrive at a number by chance. Many card games that use online systems have benefited from continued advancements in finding ways to verifiably randomize output, as is evidenced in U.S. Pat. No. 10,803,702 which describes a dual physical-electronic selection system for card games, which is particularly useful for casino and gambling operations. However, another popular system that oftentimes utilizes selection by chance is the practice of divination.

Divination has been used throughout human history in many different forms. The purpose of divination is to attempt to gain insight or advice through a ritual or practice. For example, cleromancy, the practice of throwing lots (paper, tokens, or other objects with some form of designation akin to a die) is most commonly associated with the practice of I Ching divination, which sometimes also uses coins in the selection system. Another form of divination is known as cartomancy, which is the use of either a special deck of cards or a regular 52-card playing card deck in the practice of fortune-telling or self-reflection. The method by which divination provides these answers relies strongly on providing guidance that is so abstract or non-specific that the person for whom the reading is conducted may often find a way to apply the guidance to their own life. Alternatively, spiritual or religious practitioners may rely on their spiritual beliefs and backgrounds to use these tools to arrive at a meaningful answer.

Divination practices will often focus on the practitioner or user associating their personal energy field with the divinatory tools. While this particular practice is not scientifically supported by quantifiable data, it is a popular idea rooted in spirituality, mysticism, and religious practices of multiple faiths. The practice of personal energy incorporation supports the spiritual belief of some practitioners that the advice or guidance they are receiving from a divinatory reading is coming from a mystical source or contains some otherwise unknowable information. While the idea of tapping into unknowable information remains to be proven, modern technological advancements have been successfully integrated into divinatory or spiritual practices, as evidenced by the I Ching hexagram system described in U.S. Pat. No. 8,528,903 which describes a magnetized device designed to achieve randomized I Ching readings, as well as U.S. Pat. No. 10,820,644 which describes a method of implementing new age healing techniques such as crystals and other materials which may deliver vibrational or other healing methods through placement in personal effects.

Using modern technology, interactive electronic divination tools operating on computer software allow people everywhere to access divination for entertainment, religious, or spiritual purposes without having to acquire physical tools which take up space. Interactive electronic divination tools can be run on websites, systems, and devices such as smart phones, tablets, and similar technologies. Tools simulating cartomancy may show an animated deck of cards being shuffled, or for cleromancy, they may display an animation of coins being tossed. Electronic divination tools typically utilize random number generators to shuffle the deck of cards or select the lot. Tools that rely on a random number generator to select a card or lot are only interactive in that they allow the user to select precisely when a card is drawn or when a lot is thrown. Thus due to the uniformity of their administration, selection methods that rely solely on a random number generator lack amusement or novelty in the sense that there is no additional interest in the selection method.

### BRIEF SUMMARY OF THE INVENTION

The present invention provides a method of selecting a card, lot, or number for interactive electronic media, currently configured as but not limited to a divination tool, that relies on movement and other environmental data sensors rather than a random number generator. Accordingly, the present invention provides a framework wherein the virtual deck of cards or lots can be shuffled according to measurements taken by a device's sensors which can measure variables such as electromagnetic fields, acceleration, heading, and other expressions of energy, movement, or biometrics.

In another aspect of the invention, the invention provides for a selection method that reliably generates a unique shuffling of the cards or lots upon each use. Accordingly, the present invention polls each device sensor, whose readings may be expressed in as many as 309 significant digits which can change up to 120 times each second depending on the device capabilities, and uses these values to shuffle the virtual deck or lots with a mathematical formula. The sensitivity of the readings combined with the mathematical formula ensure randomization. Therefore the shuffling method generates a unique selection which is based entirely upon the sensor data while maintaining the same probability of selection contemplated under a random number generator.

In yet another aspect of the invention, the invention provides an element of amusement by relying on an alternative method other than a random number generator for card or lot selection. Accordingly, users who seek out electronic divination tools for entertainment purposes may enjoy the aspect of the sensor readings determining the sequence in which the cards or lots are shuffled.

Aspects of the invention are not limited to the specific sensors or devices described in the description and drawings as the method is reliant only on the fact that the device upon which the tool is running contains sensors capable of measuring a combination of movement, biometrics, or environmental data. In addition, the present invention does not need to be limited to the particular tool that currently supports the invention because the invented method may be utilized in other software or systems designed to pull card, lot, or number readings in an interactive media setting. To the accomplishment of the above, this description may be embodied in the form illustrated in the accompanying drawings, which are illustrative only. Variations due to type of device and sensor capabilities are contemplated as being part of the disclosure.

### BRIEF DESCRIPTION OF THE SEVERAL VIEWS OF THE DRAWING

FIG. 1 illustrates the type of devices upon which an electronic divination tool may operate wherein the present invention is contained.

FIG. 2 illustrates the types of movement and energy which may affect the device's sensors from which the invention draws readings.

FIG. 3 illustrates the embodiment of the invention being utilized in a card or lot selection within the current user interface of the electronic divination tool.

FIG. 4 is a flow chart representation of the order of processes in the invented method.

### DETAILED DESCRIPTION OF THE INVENTION

The following detailed description illustrates the invention by way of example, not by way of limitation of the principles of the invention. This description will clearly enable one skilled in the art to make and use the invention and describes several embodiments, adaptions, variations, alternatives, and uses of the invention, including the present modality of carrying out the invention.

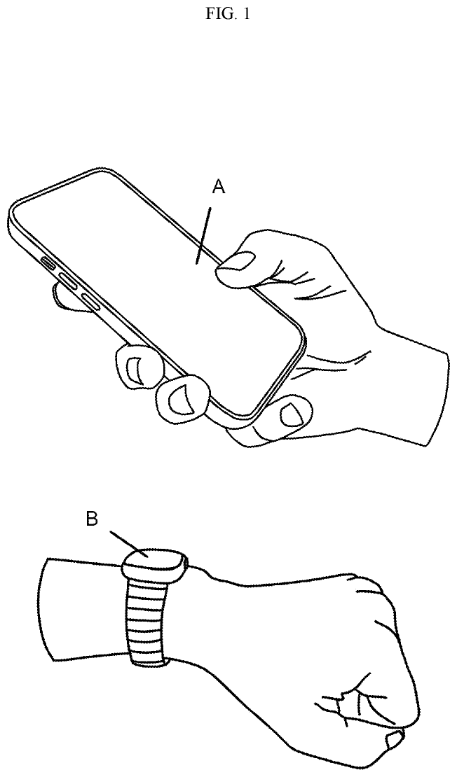

FIG. 1 illustrates two types of devices currently capable of being configured to operate an interactive electronic divination tool, which is presently configured as a computer software application designed as a mobile application for smart devices, including, but not limited to, smart phones, smart watches, smart TVs, tablets, desktop computers, or any other technology now known or that may be developed in the future upon which computer and mobile application software may operate. In FIG. 1, Element A is represented as a smart phone or mobile phone within the current technological and consumer understanding of the product. FIG. 1 Element B is represented as a smart watch with the same understanding. Neither of these elements should be limited to a particular brand, type, or class. The only device limitation for the interactive software is the need for device hardware capable of measuring movement, biometrics, or environmental data as well as the acceptance of user input, such as touch, sound, facial recognition, or other communication methods. Thus the software could easily operate on a device not listed above, such as wearable devices like smart glasses or smart jewelry, so long as the device contains or is connected to hardware with the capabilities listed above.

Similarly, while the current iteration of the computer software which comprises the invention is a particular computer application configured for mobile devices, this should not limit the invention to this particular software application as the invention itself is a method inside of one such tool. The software application presently configured is an interactive electronic divination tool, such as many other mobile applications configured for tarot card or I Ching readings and which are available in mobile device application stores across many different device platforms. However, this invention may not be limited to the framework of electronic divination tools, as it may be applied to other interactive electronic media, especially electronic card selection systems or games. Because the present invention provides an alternative to the random number generator in card or lot selection, it could feasibly be used in any system in which dice are thrown, numbers are selected, or any other selection is made from a predetermined set of options and which system relies upon a random output. This is to say that this particular invention would not be suitable for a system in which there is a right and wrong answer, but instead will work for systems that require a random answer. This is of particular appeal in the field of divination, wherein the applicability of the answers provided is largely dependent on user belief and confirmation bias. Therefore, there can be no wrong answers, since each answer is subjective. However, the present invention could just as easily find appeal within the framework of an electronic card game, board game, or other interactive story game wherein the user makes selections that are tantamount to a game of chance controlled by the rolling of a die, but which may benefit from the amusement of not relying on a random number generator. Thus the present invention should only be limited to interactive electronic media requiring random outputs from user selections, as long as the method's software and hardware requirements are met.

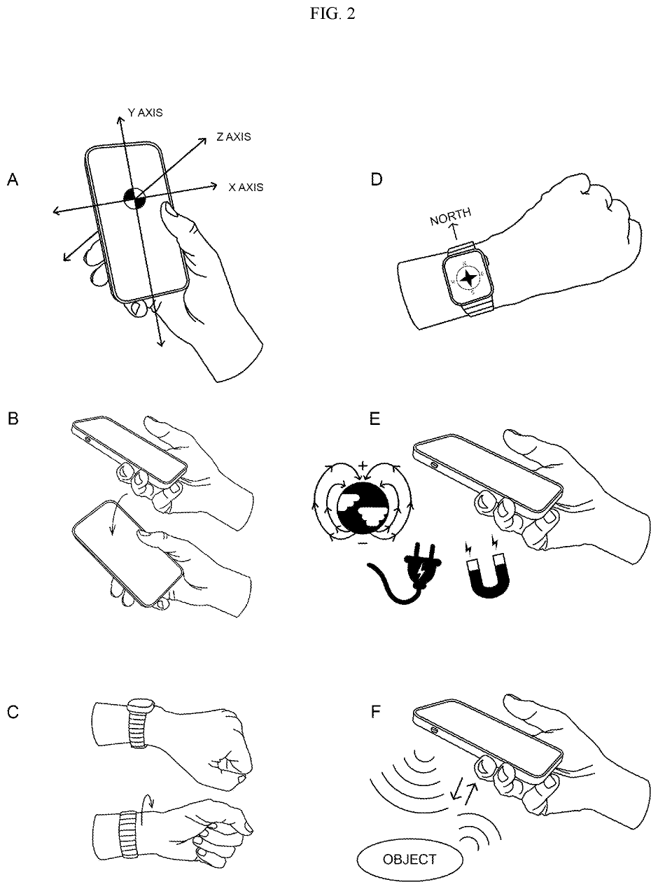

FIG. 2 illustrates six types of movement or environmental data upon which a device may currently be capable of drawing measurements which can then be utilized by the invention. The types of measurements available depend entirely on the device hardware capabilities. The software comprising the present invention can be tailored to the particular types of sensors available on certain hardware. For example, in FIG. 2, Element A depicts a device's attitude, which is measured as the orientation of a body relative to a given frame of reference. Attitude describes a body's orientation in 3D-space using pitch, roll, and yaw. Pitch reports rotation around the x axis, roll reports rotation around the y axis, and yaw reports rotation around the z axis. FIG. 2 Element B depicts a user engaging the device's accelerometer, which measures changes in velocity along an axis. Most devices have a 3-axis accelerometer which can deliver acceleration values in each axis. FIG. 2 Element C depicts a user engaging the device's gyroscope, which measures the rate at which a device rotates around a spatial axis. Most devices have a 3-axis gyroscope which can deliver rotation values in each axis. FIG. 2 Element D depicts a user engaging the device's heading sensor, which delivers its current orientation relative to magnetic or true north. FIG. 2 Element E depicts a device's magnetometer which takes measurements of the Earth's magnetic fields as well as any other electromagnetic field relative to the device. Common sources of electromagnetic fields in a home setting include electric outputs and magnetic devices. FIG. 2 Element F depicts a device's LiDAR, or Light Detection and Ranging, sensor which works in a similar way to radar but uses lasers to judge distance and depth. LiDAR uses a pulsed laser that records the time it takes for the signal to return to source, enabling it to generate a 3D model of the environment.

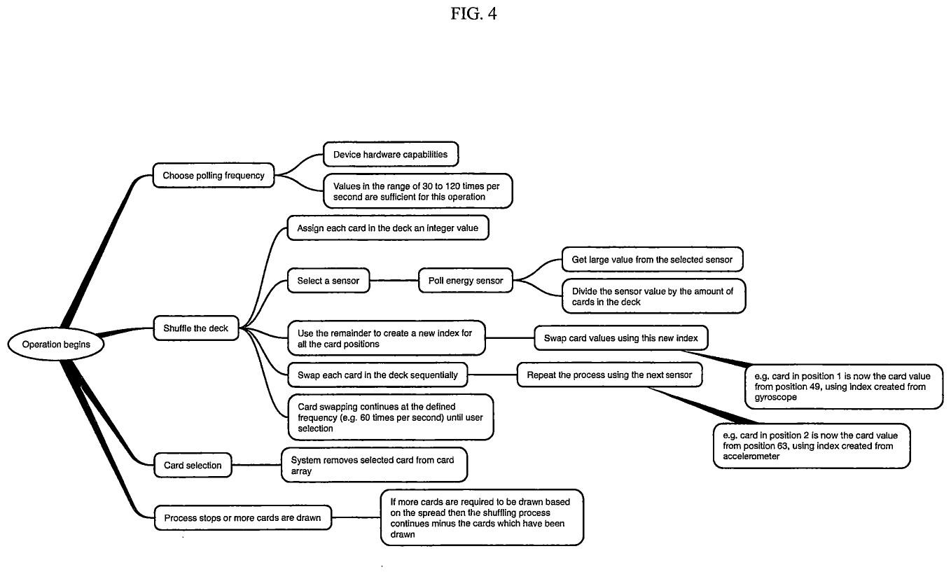

FIG. 2 illustrates only a small selection of examples of types of hardware sensors which are currently available on most mobile devices in the consumer market. However, the present invention could feasibly be configured to accept data from sensors not listed above or which are not currently available in the consumer market. For example, sensors which measure a user's biometric output such as heart rate or blood pressure might be applied, as well as other environmental data such as gravity or pressure. The key component in the data accumulation is that the data from the sensor measurement must be capable of being expressed in a numeric value which may then be utilized in the shuffling operation described in FIG. 4. Thus the present invention should only be limited to input sources based on device sensors that measure aspects of the user or the environment in a manner in which data capable of being expressed as a numeric value or values is generated.

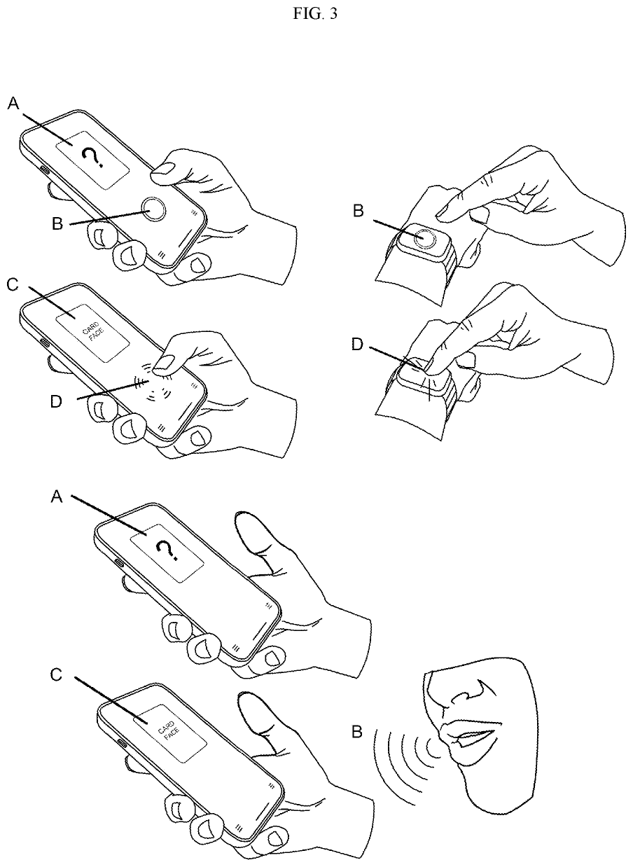

FIG. 3 illustrates three examples of the embodiment of the invention being utilized in a card or lot selection within the current user interface of the electronic divination tool. When a user is ready to select a card or lot, the shuffling operation which is described in FIG. 4 begins in the background of the software, unseen by the user. FIG. 3 describes the visual representation of this process which is viewed by the user. FIG. 3 Element A represents the card or lot which has not yet been selected as visualized on the device. FIG. 3 Element A is of course not limited to a single card or lot but may be as many unselected cards or lots as configured in the tool for a particular reading. Popular card draws can range from one card up to 20 cards. FIG. 3 Element B represents the method of user input which denotes a desire to make a card or lot selection. FIG. 3 Element B is depicted here as both touch or audio input, but the present invention could feasibly be configured to many other types of user input depending on device and software capabilities. Other such user inputs contemplated are biometric or movement based cues such as blinking or waving. FIG. 3 Element C describes the selected card or lot which is immediately revealed upon Element D, the reception of the user input, which may or may not be represented visually on the device as an animation, audio cue, or other representation. In the current configuration of the tool, Element B′s touch cue also serves as a visual representation of the shuffling operation which is happening in the background. This is achieved through an animation depicting energy and movement. The process of the user selecting cards as presented in FIG. 3 continues until all cards or lots in the reading have been selected. The visualization representations in FIG. 3 should not limit the capabilities of the user selection interface because many configurations are contemplated within, and all of the elements listed in FIG. 3 are not necessary for the present invention to operate. Thus the present invention should only be limited to user selection interfaces wherein user input denotes a desire to make a selection at a specific time.

FIG. 4 is a flow chart representation of the order of processes of the invented method and describes the mathematical formula currently configured to shuffle the deck or lots. The user begins the shuffling process by opening the card selection interface in the divination tool. Once the operation begins, the frequency with which device sensors will be polled must be selected. The polling frequency is dependent upon the device hardware capabilities, but values in the range of 30 to 120 times per second are sufficient for the operation. Most devices are capable of polling much higher than 120 times per second, however, this will often cause the device processor to work harder and affect device battery use, causing excessive energy drainage while not adding value to the user experience. Anything less than 30 times per second may be too slow which can result in a poor shuffling experience that appears to lack randomization. The current software configuration polls device sensors at 60 times per second which accommodates both the modern device battery usage issue and the concern around speed of shuffling.

The next step in the shuffling operation described in FIG. 4 is the method by which the deck is shuffled using the device sensors. First, each card or lot that is capable of being selected must be assigned an integer value to ensure that each card is listed only once and is provided an initial position in the card array. For example, if a user is going to do a five-card reading from a tarot deck containing 78 cards, then each card out of 78 must be assigned an initial value. This initial assigned value can be specific or arbitrary. The only requirement is that each card must be identified in the software and listed only once. The current software assigns arbitrary integer values in this instance. Next, the software must designate how the cards will be swapped or shuffled. To do this, a device sensor, such as those described in FIG. 2, with which to control the card swap must be selected. The sensor selection can be specific or arbitrary. The only requirement is that the sensor must be capable of expressing its measurement as a numeric value. The current configuration chooses sensors based on a sequential list of available device sensors. For example, first the gyroscope is used, then the accelerometer, then the magnetometer. The software polls the selected sensor, which provides a numeric value from the measurement which changes at the chosen frequency as discussed earlier. The value from the selected sensor is capable of being interpreted by the software as a large numeric value, rather than as a fraction.

This interpretation of the sensor value can result in a very large number sometimes containing up to 309 significant digits. The sensor value is then divided by the amount of cards in the deck. In the example, the extremely large 309 digit number is divided by 78 which represents the amount of cards capable of being selected. This division results in a remainder. The software uses the remainder to create a new index for each card position. The new index is used to swap, or shuffle, the cards by going through the initially assigned positions in the card array sequentially and swapping each card. For example, the card in initial position 1, which may be Ace of Cups, becomes the card value from position 49, which may be Seven of Swords, using the new index created using the gyroscope value. This swapping occurs sequentially for each card in the deck, with each card swap using the next device sensor in sequence. Therefore, in the example, the card in position 2 is then swapped using a new index created from the accelerometer value. This entire process is repeated for every card in the deck at the previously discussed frequency, which is currently configured at 60 times per second.

The benefit of using the large value interpretations of the sensor values is that even micro-changes from the user or the environment, which may be imperceptible to human touch or sight, will create a sufficient change in the value to produce a variation in each shuffle. For example, even an inert device sitting on a flat surface will experience sensor measurements in attitude, acceleration, and electromagnetic field that have changes in the least significant digit spaces, but these changes are still enough to create a new value each time when finding the remainder. Since these large value sensor readings are changing at 60 times each second, this also ensures that the speed with which the values are changing creates unique variations and allows the user's movement or environmental data input to affect the shuffling of the cards. Using the sensors in sequence provides another way to ensure unique readings since it gives each sensor time to bring in new data before being polled again. There is no limit to the amount of sensors that can be utilized in this process, but the operation will work best with more than one sensor. It could, however, be used with only one. In addition, the user is never required to wait for the cards to be shuffled since the shuffling process is so fast it may feasibly be hidden behind the graphic user interface beginning before the user is physically even able to select a card.

FIG. 4 continues the operation with the observation that the card swapping process will continue indefinitely until the user makes a card selection with the appropriate method as described earlier. The current configuration of the software utilizes touch input on a device to indicate that the user desires for a card to be drawn. In the example of a five-card reading, the user would select the first of five cards, which would then be revealed through an animation in the divination tool. When the user indicates that a card should be selected, the software selects whichever card is at position 1, which through the shuffling process may be any of the cards in the array as described above. Once a card is selected, the software removes that card from the position array so that it can no longer be selected. The shuffling process described above then continues with the new array of available cards until another card is selected, in which case the process repeats until all cards in the reading have been selected. At this point the operation is complete. While the current embodiment utilizes this particular mathematical formula to shuffle the cards and arrive at a card selection, there are other mathematical configurations capable of manipulating device sensor readings to arrive at a randomizing card shuffling process, and the current invention should not be limited to the current configuration. Thus the invention requires a system, software, or platform which is capable of completing a similar mathematical formula to utilize the sensor measurements to shuffle the cards and arrive at a randomized card selection.

The present invention has been described above in terms of a currently preferred embodiment so that an understanding of the present invention can be conveyed. There are, however, many configurations for card and lot selection methods based on movement, biometrics, and environmental data detection sensors not specifically described herein but to which the present invention is applicable. The present invention should therefore not be seen as limited to the particular embodiments described herein, but rather, it should be understood that the present invention has wide applicability with respect to card, lot, and number selection methods utilizing movement, biometrics, or environmental data detection sensors generally. All modifications, variations, or equivalent arrangements and implementations that are within the scope of the attached claims should therefore be considered within the scope of the invention.

The invention claimed is:

1. A method for selecting a card, lot, or number using a shuffling process that relies on measurements of movement, biometrics, or environmental data taken from a device with sensors capable of making such measurements.

2. The method for selection as recited in claim 1, wherein the measurements taken are capable of being expressed in a numeric value or values.

3. The method for selection as recited in claim 2, wherein it operates within interactive electronic media that requires a random output or selection.

4. The method for selection as recited in claim 3, wherein it utilizes a selection interface allowing for user input to denote a desire to make a selection at a specific time.

5. The method for selection as recited in claim 4, wherein the shuffling process utilizes mathematical formulas to direct the shuffling of cards or lots in collaboration with sensor data.
